(19) United States
(12) Patent Application Publication
(10) Pub. No.: US 2005/0052502 A1
(43) Pub. Date: Mar. 10, 2005

(54) Thermal bubble membrane microfluidic actuator

(75) Inventors: Chen-Kuei Chung, Hsinchu (TW); Sway Chuang, Ping Dong (TW); Chung-Chu Chen, Taichung (TW)

Correspondence Address: SHAW PITTMAN LLP, 1650 Tysons Boulevard, McLean, VA, 22102, US

(73) Assignee: Industrial Technology Research Institute.,

(21) Appl. No.: 10/656,755

(22) Filed: Sep. 6, 2003

(51) Int. Cl. B41J 2/05

(52) U.S. Cl. 347/65

(57) ABSTRACT

A thermal bubble membrane actuator for ejecting a liquid which includes a base substrate, a first plurality of heating elements, a first plurality of electrodes, a first plurality of expansion chambers, and elastic membrane sealing the chambers, a liquid flow channel formed in a second thick film photoresist layer, and a top substrate sealing the liquid flow channel having a liquid inlet and a liquid outlet formed therein.

### FIELD OF THE INVENTION

The present invention generally relates to a microelectronic device fabricated by microelectronic fabrication processes and more particularly, relates to a microfluidic actuator which utilizes thermal bubble membrane for dispensing a liquid and a method for fabricating the microfluidic actuator.

### BACKGROUND OF THE INVENTION

Microfluidic actuators for dispensing liquids are fabricated by micro-electrical-mechanical system (MEMS) techniques. Presently, microfluidic actuators fabricated by the MEMS technology include the electrostatic-type, the piezoelectric-type, the electromagnetic-type, the thermal-activated type and the pneumatic driven type. A common drawback of the microfluidic actuators fabricated by these techniques is the lack of efficient control of the fluid flow volume and, furthermore, the difficulty in integrating the device into a portable system. For instance, the electrostatic-type and the piezoelectric-type devices require a high working voltage of more than 110 volts, while the electromagnetic-type and the thermally actuated type devices require a high power consumption of 1000 mW. Moreover, the pneumatic-driven type device has the drawback of requiring a large pneumatic source for the drive and thus, it has lost the portability of a system fabricated by the MEMS technology. In conclusion, the common drawbacks of the microfluidic actuators are the lack of an efficient means for controlling the fluid flow and the lack of integration into a portable system.

It is therefore an object of the present invention to provide a thermal bubble membrane microfluidic actuator that does not have the drawbacks or shortcomings of the conventional microfluidic actuators.

It is another object of the present invention to provide a thermal bubble membrane actuator that is capable of accurately controlling the fluid flow rate.

It is a further object of the present invention to provide a thermal bubble membrane actuator that can be fabricated into an integrated, portable system.

It is another further object of the present invention to provide a thermal bubble membrane actuator that can be operated at low working voltage and low power consumption.

It is still another object of the present invention to provide a thermal bubble membrane actuator that can be operated in a wide range of flow rates.

It is yet another object of the present invention to provide a method for fabricating a thermal bubble membrane actuator by MEMS technology.

### SUMMARY OF THE INVENTION

In accordance with the present invention, a thermal bubble membrane actuator for ejecting a liquid and a method for fabricating the actuator are provided.

In a preferred embodiment, a thermal bubble membrane actuator for ejecting a liquid is provided which includes a base substrate of a semi-conducting material; a first plurality of heating elements formed on the base substrate; a first plurality of electrodes each in electrical communication with one of the first plurality of heating elements; a first plurality of chambers formed in a first thick film photoresist layer with one of the first plurality of chambers formed on top of each of the first plurality of heating elements; a membrane on top of the first thick film photoresist layer sealing a top of each of the plurality of chambers; a liquid flow channel formed in a second thick film photoresist layer on top of the membrane; a top substrate sealing a top of the liquid flow channel; and a liquid inlet and a liquid outlet formed in a top substrate, each in fluid communication with the liquid flow channel.

In the thermal bubble membrane actuator for ejecting a liquid, the base substrate may be a silicon substrate, wherein the first plurality may be three. The first plurality of chambers may be three chambers with one chamber positioned juxtaposed to the liquid inlet and another chamber positioned juxtaposed to the liquid outlet. The membrane may be formed of a material that has an elasticity of at least that of silicon rubber.

In a thermal bubble membrane actuator, the membrane seals a top of the plurality of chambers to form a plurality of hermitically sealed chambers. The membrane may be formed of a material selected from the group consisting of silicon rubber, PDMS and polyparylene. The first plurality of heating elements may be formed of a material selected from the group consisting of TaAl, AfBz, Pt, AuCr and polysilicon. A middle chamber in the three chambers cooperates with a middle heating element to function as an anti-back flow valve.

The present invention is further directed to a method for fabricating a thermal bubble membrane actuator which can be carried out by the operating steps of providing a base substrate of a semi-conducting material; depositing a layer of a high electrical resistance material on top of the base substrate; forming a first plurality of heating elements from the layer of high electrical resistance material; depositing a layer of high electrical conductance material on the first plurality of heating elements; forming a first plurality of electrodes from the layer of high electrical conductance material each in electrical communication with one of the first plurality of heating elements; laminating a first thick film photoresist layer on top of the first plurality of electrodes and the first plurality of heating elements; forming a first plurality of chambers with one on top of each of the plurality of heating elements in said first thick film photoresist layer; laminating a membrane on top of the first plurality of chambers sealing a top of each of the plurality of chambers; laminating a second thick film photoresist layer on top of the membrane; forming a liquid flow channel in the second thick film photoresist layer; laminating a top substrate onto and sealing a top of the liquid flow channel; and forming a liquid inlet and a liquid outlet in the top substrate each in fluid communication with the liquid flow channel.

The method for fabricating a thermal bubble membrane actuator may further include the step of providing the base substrate in a silicon substrate, or selecting the high electrical resistance material from the group consisting of TaAl, AfBz, Pt, AuCr and polysilicon. The method may further include the step of selecting a material for the membrane from the group consisting of silicon rubber, PDMS and polyparylene, or the step of forming the first plurality of chambers in air-tight chambers.

### BRIEF DESCRIPTION OF THE DRAWINGS

These and other objects, features and advantages of the present invention will become apparent from the following detailed description and the appended drawings in which:

FIGS. 1A and 1B are enlarged, cross-sectional views illustrating the working principle of the present invention thermal bubble membrane actuator.

FIG. 2 is an enlarged, cross-sectional view of a present invention thermal bubble membrane actuator equipped with a liquid inlet, liquid outlet and an anti-backflow valve thereinbetween.

FIGS. 3A and 3B are enlarged, cross-sectional views illustrating the various flow pattern controls of the present invention thermal bubble membrane actuator shown in FIG. 2.

FIGS. 4A and 4B are enlarged perspective and plane view of another embodiment of the present invention thermal bubble membrane actuator.

### DETAILED DESCRIPTION OF THE PREFERRED AND ALTERNATE EMBODIMENTS

The invention discloses a thermal bubble membrane actuator for ejecting a liquid which is formed by a base substrate, a plurality of heating elements, a plurality of chambers, a membrane sealing the plurality of chambers, a liquid flow channel, a top substrate sealing the liquid flow channel, and a liquid inlet and a liquid outlet formed in the top substrate.

The invention further discloses a MEMS technique for forming the thermal bubble membrane actuator.

In the present invention, thermal bubble membrane actuator, a low voltage of only about 10 volts is required to produce a thermal bubble and thereby ejecting liquid. The power consumption of the present invention thermal bubble membrane actuator is less than 10 mW, which is substantially less than all other forms of actuators formed by MEMS technology. The driving frequency range has a broad range between about 1 Hz and about 10 E4 hz. The maximum flow rate achievable by the present invention thermal bubble membrane actuator is wide, for instance, in the range between about 1 and about 10 E4 micro-liter/min.

The present invention thermal bubble membrane actuator utilizes a thermal bubble, i.e., a heated bubble to press on an elastic membrane and thus pressurizing a fluid flow channel for ejecting a fluid from the channel. The pressure differential cost by the expansion of the elastic membrane enables a fast flow rate, a wide range of flowback volume and an accurate control of the fluid flow. This is favorably compared to other micro-fluidic actuators fabricated by the MEMS technology which require high working voltage, high power consumption which achieving only a low driving frequency.

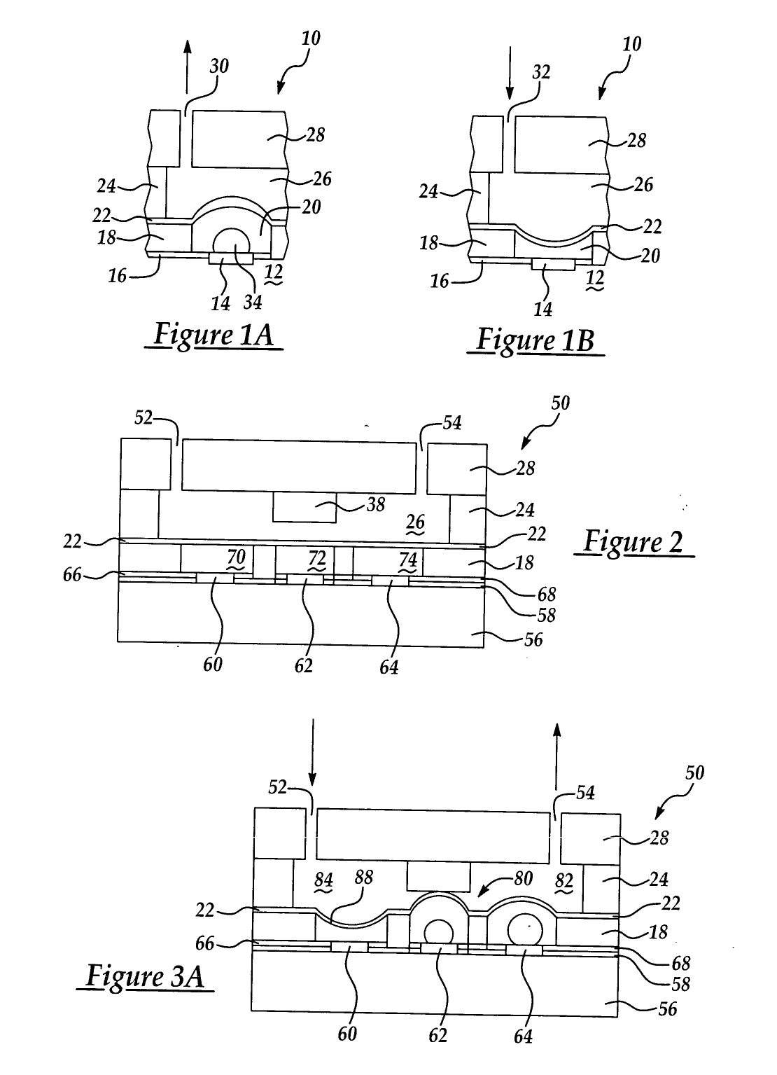

Referring initially to FIGS. 1A and 1B wherein the working principle of the present invention thermal bubble membrane actuator 10 is shown. The thermal bubble membrane actuator 10 is constructed by a base substrate 12, a heating element 14, an electrode 16 for providing power to the heating element 14, a first thick film photoresist layer 18 wherein an expansion chamber 20 is formed, a membrane 22 which seals the top of the expansion chamber 20, a second thick film photoresist layer 24 in which a fluid flow channel 26 is formed, a top substrate 28 for sealing the liquid flow channel 26, and a liquid outlet (FIG. 1A) or a liquid inlet 32 (FIG. 1B) formed in the top substrate 28. The process for forming each layer will be described in detail in a later section.

As shown in FIG. 1A, when a low boiling point liquid is filled into the expansion chamber 20, the heating element 14 heats up the low boiling point liquid producing a thermal bubble 34 and thus pushing the membrane 22 upwardly, i.e., or expanding the volume of the expansion chamber 20. The expansion while pushing upward of the membrane 22 pushes the liquid contained in the fluid flow channel 26 and thus ejecting the liquid from liquid outlet 30.

When the electric power to the heating element 14 is interrupted, the thermal bubble 34 disappears in the expansion chamber 20 and thus causing the membrane 22 to retract into the chamber 20. This is shown in FIG. 1B. A liquid thus flows into the fluid flow chamber 26 through the liquid inlet 32. A change in the total volume of the expansion chamber 20 thus ejects out or retracts in liquid through the expansion or retraction of the elastic membrane 22 and the generation of the thermal bubble 34.

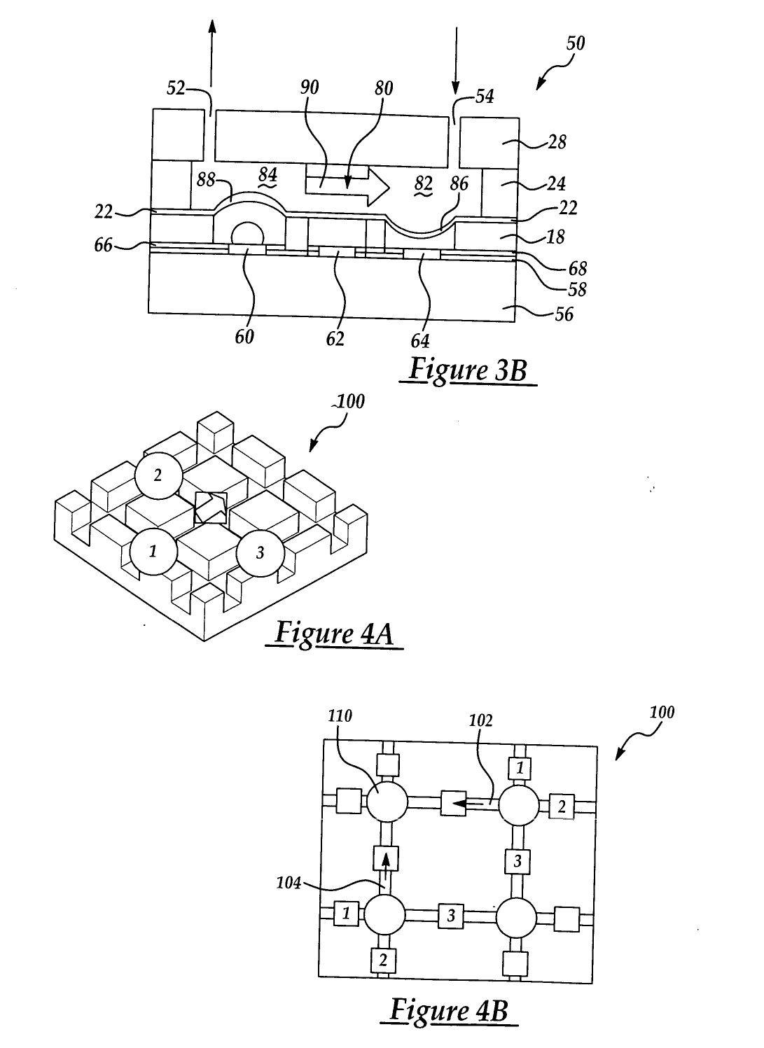

FIG. 2 shows an enlarged, cross-sectional view of a present invention thermal bubble membrane actuator 50 which includes two liquid passageways 52, 54, each may be a liquid outlet or a liquid inlet. The thermal bubble membrane actuator 50 is constructed by a semiconducting substrate 56 which may be a silicon substrate. A dielectric insulating layer 58 and a plurality of heating elements 60, 62 and 64 are then formed on the base substrate 56. The heating element 60 and 64 are each electrically connected to electrode 66 and 68, while the electrode connecting to the heating element 62 is not shown in FIG. 2. Three expansion chambers 70, 72 and 74 are formed each encompassing a heating element 60, 62 and 64, respectively. The expansion chamber 70, 72 and 74 are formed in a first thick film photoresist layer that is laminated to the top of the electrodes 66, 68 and the heating elements 60, 62 and 64. An elastic membrane 22 is then formed on top of the first thick film photoresist layer 18 to seal the top of the expansion chambers 70, 72 and 74. As a result, hermitically sealed air-tight chambers are formed. After a second thick film photoresist layer 24 is laminated to the top of the elastic membrane 22, a fluid flow channel 26 is formed by a standard photolithographic method. It should be noted that part of the thick film photoresist layer is retained, which is designated as a stop 38 in FIG. 2 to function as part of an anti-backflow valve 80 which is shown in FIG. 3A.

The mode of operation of the thermal bubble membrane actuator 50 shown in FIG. 2 is shown in FIGS. 3A and 3B. Similar to the operating principle shown in FIGS. 1A and 1B, the fluid flow passageway 52 in FIG. 3A functions as a liquid inlet, while the fluid flow passageway 54 functions as a liquid outlet. This is reversed in the operating mode shown in FIG. 3B. The operation of the anti-backflow valve 80 in the present invention thermal bubble membrane actuator is also shown in FIG. 3A which prevents liquid contained in chamber 82 from backflowing into chamber 86 during the ejection of liquid from liquid outlet 54 by the expansion of membrane 86 and the retraction of membrane 88.

A reverse operating mode is shown in FIG. 3B when the power to heating element 62 is turned off and thus the anti-backflow valve 80 is deactivated which allows a liquid flow from chamber 84 to chamber 82 as shown by the arrow 90.

The elastic membrane 22 utilized in the present invention thermal bubble membrane actuator can be formed by a material that has the elasticity at least that of silicon rubber. Suitable materials may be silicon rubber, PDMS or polyparylene. The heating elements 60, 62 and 64 may be suitably formed by a material that has a high electrical resistance such as TaAl, AfBz, Pt, AuCr and polysilicon. Any suitable thick film photoresist material may be used for the two thick film photoresist layers 18 and 24. A suitable thickness for the thick film photoresist layers may be between about 1 Å to about 1000 Å.

An alternate embodiment of the present invention thermal bubble membrane actuator 100 is shown in FIGS. 4A and 4B. As shown in FIG. 4A, three elastic membranes are provided at passageways marked in circles as 1, 2 and 3, each allowing a liquid to be pushed toward the center of the actuator 100. Similarly, the three elastic membranes 1, 2 and 3 are also shown in FIG. 4B allowing liquid to flow in the directions as marked by the arrow 102 and 104 toward a reactor 110. By utilizing the present invention thermal bubble membrane actuator, any desirable, convenient flow channels can be designed to suit a special application requirements.

The present invention thermal bubble membrane actuator can be advantageously fabricated by a process described as follows. A base substrate is first provided which may be formed of a semi-conducting material such as a silicon substrate. A layer of high electrical resistance material is then deposited on top of the base substrate for forming, by a standard photolithographic method, a plurality of heating elements. A layer of high electrical conductance material is then deposited on top of the structure to form a plurality of electrodes each in electrical communication with one of the plurality of heating element. A first thick film photoresist layer is then deposited on top of the electrodes and the heating elements for forming a plurality of expansion chambers in the thick film photoresist layer with one on top of each of the heating elements. A membrane layer is then formed or laminated on top of the plurality of expansion chamber to seal a top of each of the chambers, followed by the lamination of a second thick film photoresist layer on top of the membrane layer. A liquid flow channel is then formed, by standard photolithographic method in the second thick film photoresist layer. A top substrate which has at least one liquid inlet and liquid outlet formed therein is then laminated or otherwise formed onto the top of the liquid flow channel, thus sealing the liquid flow channel.

While the present invention has been described in an illustrative manner, it should be understood that the terminology used is intended to be in a nature of words of description rather than of limitation.

Furthermore, while the present invention has been described in terms of one preferred and one alternate embodiment, it is to be appreciated that those skilled in the art will readily apply these teachings to other possible variations of the inventions.

The embodiment of the invention in which an exclusive property or privilege is claimed are defined as follows.

1. A thermal bubble membrane actuator for ejecting a liquid comprising:
a base substrate of a semi-conducting material;
a first plurality of heating elements formed on said base substrate;
a first plurality of electrodes each in electrical communication with one of said first plurality of heating elements;
a first plurality of chambers formed in a first thick film photoresist layer with one of said first plurality of chambers formed on top of each of said first plurality of heating elements;
a membrane on top of said first thick film photoresist layer sealing a top of each of said plurality of chambers;
a liquid flow channel formed in a second thick film photoresist layer on top of said membrane;
a top substrate sealing a top of said liquid flow chamber; and
a liquid inlet and liquid outlet formed in said top substrate each in fluid communication with said liquid flow channel.

2. A thermal bubble membrane actuator for ejecting a liquid according to claim 1, wherein said base substrate is a silicon substrate.

3. A thermal bubble membrane actuator for ejecting a liquid according to claim 1, wherein said first plurality is three.

4. A thermal bubble membrane actuator for ejecting a liquid according to claim 1, wherein said first plurality of chambers is three chambers with one chamber positioned juxtaposed to said liquid inlet and another chamber positioned juxtaposed to said liquid outlet.

5. A thermal bubble membrane actuator for ejecting a liquid according to claim 1, wherein said membrane is formed of a material having an elasticity of at least that of silicon rubber.

6. A thermal bubble membrane actuator for ejecting a liquid according to claim 1, wherein said membrane sealing a top of said plurality of chambers forming a plurality of hermitically scaled chambers.

7. A thermal bubble membrane actuator for ejecting a liquid according to claim 1, wherein said membrane is formed of a material selected from the group consisting of rubber, PDMS, and polyparylene.

8. A thermal bubble membrane actuator for ejecting a liquid according to claim 1, wherein said first plurality of heating elements is formed of a material selected from the group consisting of TaAl, AfBz, Pt, AuCr and polysilicon.

9. A thermal bubble membrane actuator for ejecting a liquid according to claim 3, wherein a middle chamber in said three chambers cooperating with a middle heating element functions as an anti-back flow valve.

10. A method for fabricating a thermal bubble membrane actuator comprising the steps of:
providing a base substrate of a semi-conducting material;
depositing a layer of high electrical resistance material on top of said base substrate;
forming a first plurality of heating elements from said layer of high electrical resistance material;
depositing a layer of high electrical conductance material on said first plurality of heating elements;
forming a first plurality of electrodes from said layer of high electrical conductance material each in electrical communication with one of said first plurality of heating elements;
laminating a first thick film photoresist layer on top of said first plurality of electrodes and said first plurality of heating elements;
forming a first plurality of chambers with one on top of each of said plurality of heating elements in said first thick film photoresist layer;
laminating a membrane on top of said first plurality of chambers sealing a top of each of said plurality of chambers;
laminating a second thick film photoresist layer on top of said membrane;
forming a liquid flow channel in said second thick film photoresist layer;
laminating a top substrate onto and sealing a top of said liquid flow channel; and
forming a liquid inlet and a liquid outlet in said top substrate each in fluid communication with said liquid flow channel.

11. A method for fabricating a thermal bubble membrane actuator according to claim 10, further comprising the step of providing said base substrate in a silicon substrate.

12. A method for fabricating a thermal bubble membrane actuator according to claim 10, further comprising the step of selecting said high electrical resistance material from the group consisting of TaAl, AfBz, Pt, AuCr and polysilicon.

13. A method for fabricating a thermal bubble membrane actuator according to claim 10, further comprising the step of selecting a material for said membrane from the group consisting of silicon rubber, PDMS and polyparylene.

14. A method for fabricating a thermal bubble membrane actuator according to claim 10, further comprising the step of forming said first plurality of chambers in air-tight chambers.
